(19) United States
(12) Patent Application Publication
(10) Pub. No.: US 2013/0189635 A1
(43) Pub. Date: Jul. 25, 2013

(54) METHOD AND APPARATUS PROVIDING SEPARATE MODULES FOR PROCESSING A SUBSTRATE

(71) Applicant: FIRST SOLAR, INC., Perrysburg, OH (US)

(72) Inventors: Chong Lim, Holland, OH (US); Oleh Petro Karpenko, Richmond, CA (US); Akhlesh Gupta, Sylvania, OH (US)

(73) Assignee: FIRST SOLAR, INC., Perrysburg, OH (US)

(21) Appl. No.: 13/748,344

(22) Filed: Jan. 23, 2013

Related U.S. Application Data
(60) Provisional application No. 61/590,616, filed on Jan. 25, 2012.

(51) Int. Cl. F27D 3/00

(52) U.S. Cl. CPC F27D 3/00
USPC 432/11; 432/77; 432/49

(57) ABSTRACT

A method and apparatus for heat treating a photovoltaic device. The apparatus includes a heating module, a processing module, and a cooling module in which the operating temperatures of the modules may be controlled separately. The heating module is configured to pre-heat a substrate and stabilize the substrate at the desired target temperature, the processing module is configured to thermally process the substrate, and the cooling module is configured for post-treatment cooling of the substrate.

This application claims the benefit of priority of U.S. Provisional Patent Application No. 61/590,616, filed Jan. 25, 2012, entitled: “Method and Apparatus Providing Separate Modules For Processing a Substrate,” the entirety of which is incorporated by reference herein.

### FIELD OF THE INVENTION

Embodiments described herein relate generally to a method and apparatus for preheating, processing, and cooling down a photovoltaic module during fabrication.

### BACKGROUND OF THE INVENTION

A photovoltaic device converts the energy of sunlight directly into electricity by the photovoltaic effect. FIG. 1 is a cross-sectional view of a portion of one example of a thin-film photovoltaic module 10 that can be built in layer sequence on a glass substrate 110, e.g. soda-lime glass. A multi-layered transparent conductive oxide (TCO) stack 150 can be used as an n-type front contact. The TCO stack 150 has several functional layers including a barrier layer 120, a TCO layer 130 and a buffer layer 140. The front contact can affect various device characteristics such as visual quality, conversion efficiency, stability and reliability. Window layer 160, which is a semiconductor layer, is formed over front contact 150. Absorber layer 170, which is also a semiconductor layer, is formed over window layer 160. Window layer 160 and absorber layer 170 can include, for example, a binary semiconductor such as group II-VI or III-V semiconductors, such as, for example, ZnO, ZnS, ZnSe, ZnTe, CdO, CdS, CdSe, CdTe, MgO, MgS, MgSe, MgTe, HgO, HgS, HgSe, HgTe, AlN, AlP, AlAs, AlSb, GaN, GaP, GaAs, GaSb, InS, InN, InP, InAs, InSb, TlN, TlP, TlAs, TlSb or mixtures thereof. An example of a window layer and absorbing layer can be a layer of CdS and a layer of CdTe, respectively. Back contact 180 is formed over absorber layer 170. Back contact 180 may also be a multi-layered stack similar to front contact 150. Back support 190, which may also be a glass, is formed over back contact 180.

The various layers of the photovoltaic devices may undergo a variety of processes, including surface modification, doping activation, and heat treatment. Further, a variety of deposition processes may be used, each of which may require heating the device to a processing temperature, treating the device at the processing temperature, and then cooling the device to an ambient temperature before proceeding to the final processing steps, which may include packaging, shipping, etc.

Currently, most thermal treatments are performed in a single oven. However, such ovens are not specifically designed for handling the successive steps of heating, processing, and cooling the device thereafter and therefore lack flexibility to perform each function efficiently and effectively. What is needed is a system to perform the specific functions of heating, processing, and cooling a device under fabrication efficiently and effectively.

### BRIEF DESCRIPTION OF THE DRAWINGS

FIG. 1 is a cross-sectional view of a portion of an example of a photovoltaic device.

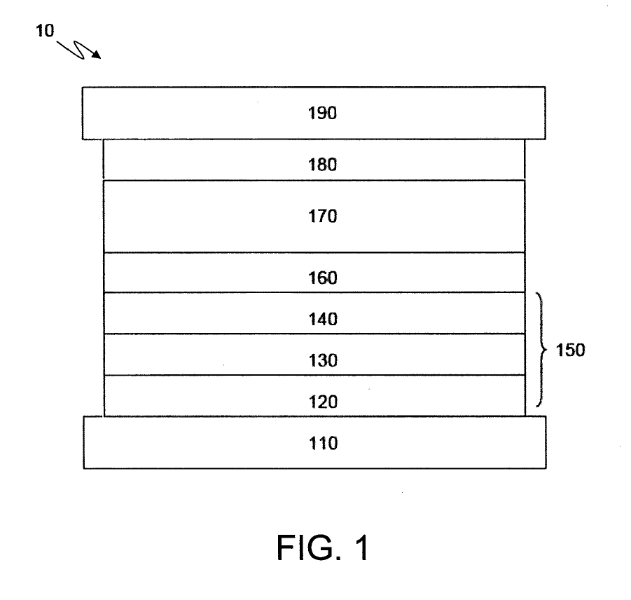

FIG. 2 shows a system for heat treating a semiconductor on a glass sheet substrate according to an embodiment described herein.

FIG. 3 shows a temperature feedback control loop for a heating module according to an embodiment described herein.

FIG. 4 shows a heating module according to an embodiment described herein.

FIG. 5 shows a processing module according to an embodiment described herein.

FIG. 6 shows a temperature feedback control loop for a processing module according to an embodiment described herein.

FIG. 7 shows a cooling module according to an embodiment described herein.

FIG. 8 shows a temperature feedback control loop for a cooling module according to an embodiment described herein.

### DETAILED DESCRIPTION

In the following detailed description, reference is made to the accompanying drawings, which form a part hereof, and in which is shown by way of illustration specific embodiments that may be practiced. It should be understood that like reference numbers represent like elements throughout the drawings. Embodiments are described in sufficient detail to enable those skilled in the art to make and use them, and it is to be understood that structural, material, electrical, and procedural changes may be made to the specific embodiments disclosed, only some of which are discussed in detail below.

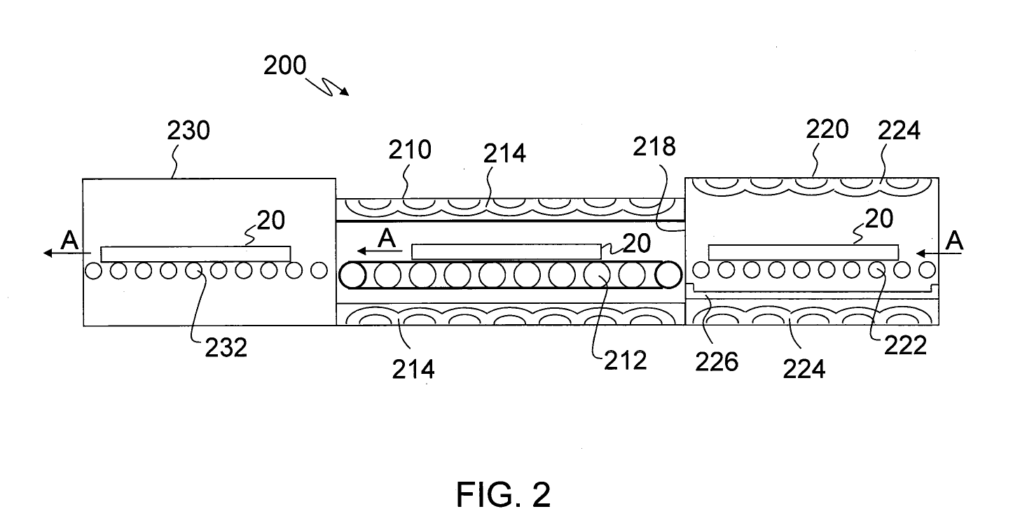

FIG. 2 shows an embodiment of a modularized oven 200 that includes three discrete modules optimized for specific purposes. The modules include a heat-up and stabilization module, referred to herein as heating module 220, an activation, treatment and deposition zone, referred to herein as processing module 210, and a post-treatment and cooling zone, referred to herein as cooling module 230. The heating module 220, processing module 210, and cooling module 230 are modular so that they may be coupled together and taken apart as needed for particular fabrication applications. For example, a particular module oven 200 could include or lack a heating module 220 and/or a cooling module 230, and could include one or more processing modules 210.

The heating module 220 is configured to heat up a substrate 20 in a rapid and uniform manner and stabilize the substrate 20 at a desired target temperature. The heating module 220 may include a plurality of rollers 222 to transport the substrate 20 there-through. The spacing between the plurality of rollers 222 and their low thermal mass allows heat to reach the substrate 20, providing a rapid and even heating process. In other embodiments, the rollers 222 could be replaced with a different transport mechanism, so long as the transport mechanism allows heat to rapidly and evenly reach the substrate 20. For example, the transport mechanism could be a wire mesh belt transport. On-board metrology of the heating module 220 may measure the position, dimensions, and temperature of the substrate 20 as it is transported through the heating module 220.

The heating module 220 may include heaters 224 arranged inside the module 220 on both the top and bottom portions of the module 220. The distance between the heaters 224 above the substrate 20 and below the substrate 20 may be equal to provide equal amounts of heat to the substrate 20. The distance may be, for example, approximately 2 to 6 inches, which facilitates rapid and even heating of the substrate 20. In various embodiments, a plurality of heating elements of the heaters 224 may be oriented in a direction that is parallel or perpendicular to the path of travel A of the substrate 20 through section 220 to achieve greater temperature uniformity.

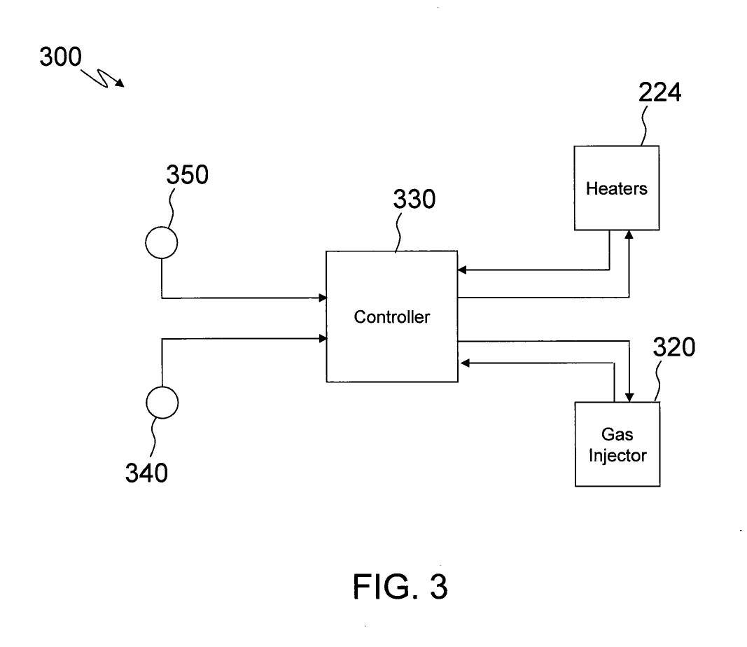

In addition to, or in lieu of the heaters 224, the temperature of the heating module 220 may be controlled using heated gas (e.g., an inert gas) introduced through a gas injector 320 (FIG. 3). By this method, heated inert gas may be injected into the heating module 220 to displace oxygen and to heat the substrate 20.

The temperature of the heating module 220 is controlled independently of the processing module 210 and cooling module 230 to allow independent optimization of the heating conditions. FIG. 3 shows a temperature feedback control loop 300 based on an in-situ temperature control to obtain the desired temperature within the heating module 220. The in-situ metrology serves to monitor and adjust for deviations in substrate temperature from the target temperature to achieve greater consistency in temperature prior to the substrate 20 entering the processing module 210. The feedback control loop 300 includes a controller 330 to control the temperature of the heaters 224 or the temperature and output of the gas from the heated gas injector 320, depending on which is used for heating. Alternatively, both heaters 223 and gas injector 320 can be used simultaneously. The controller 330 may receive input from the heaters 224 and the gas injector 320 that indicates the temperature of the heaters 224 and the temperature and output volume of the gas from the gas injector 320. The controller 330 may also receive input from a substrate temperature sensor 340 that monitors the temperature of the substrate 20. The substrate temperature sensor 340 may, for example, be a thermal imager in a spot configuration or line scanner configuration. In another embodiment, the substrate temperature sensor 340 may be a spectrometer and could monitor black body radiation using a black body curve. The controller 330 may also receive input from an ambient temperature sensor 350 that measures the internal temperature of the atmosphere inside the heating module 220. In one embodiment, the ambient temperature sensor 350 may monitor air temperature inside the heating module 220 at various locations to measure heat loss from the various parts of the module 220 and to monitor changes that result therefrom. Using the various sensor inputs and controlling the output of the heaters 224 and/or the gas injector 320, the temperature feedback control loop may be optimized to maintain a +/−1° C. control of the substrate 20 temperature prior to the substrate 20 entering the processing module 210.

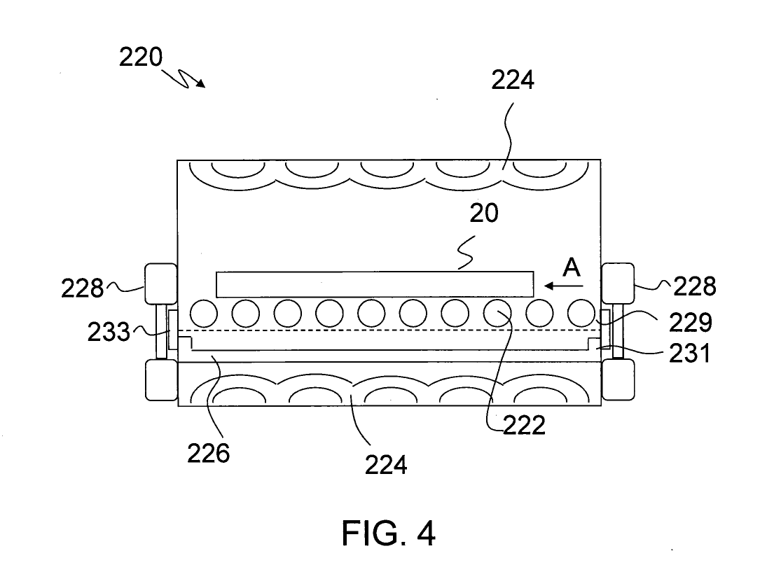

Referring back to FIG. 2, the heating module 220 may also include one or more catch trays 226 arranged underneath the rollers 222 for removing substrates 20 that may have been broken due to defects in the substrate or because of the high temperatures within the heating module 220. In one embodiment, each catch tray 226 may be made of wire mesh to allow heat to easily pass through to the substrate 20. In another embodiment, each catch tray 226 may be arranged below the lower heater 224 so as to not block heat from reaching the substrate 20. FIG. 4 shows a heating module 220 that includes a hydraulic lift 228 to lift up the top 229 of the module 220 from the bottom 231 of the module 220. The heating module 220 may also include side latches and/or hinges 233 to release the top 229.

After the substrate 20 is heated in the heating module 220, the substrate may be transported along the rollers 222 into the processing module 210 (FIG. 2). The processing module 210 is configured to process substrate 20 and/or a film stack arranged on substrate 20. This processing may include a thermal processing of the substrate 20. The processes carried out in the processing module 210, which inherently require thermal processing may include, for example, exposing the substrate 20 to vapor deposition, surface etching, dopant introduction and/or activation, film deposition, and surface passivation, among others.

To transport the substrate 20, the processing module 210 may include a belt transport 212 having a solid belt upon which the substrate 20 rests. The belt transport 212 may serve a dual purpose of protecting the bottom of the substrate 20 from chemical vapors introduced into the processing module 210 and to increase the thermal mass of the processing module 210 to maintain a steady temperature. In other embodiments, other transport mechanisms could be used.

The processing module 210 may include heaters 214 arranged outside muffle 218 of the module 210. The muffle 218, which is the enclosed treatment box portion of the processing module 210, may be made of metal such as Inconel, molybdenum, stainless steel, tungsten, and alloys thereof. The metal of the muffle 218 may transmit the heat from the heaters 214 into the interior of the processing module 210. The belt transport 212 may be situated so that the top of the muffle 218 is about 1 to 3 inches from the substrate 20.

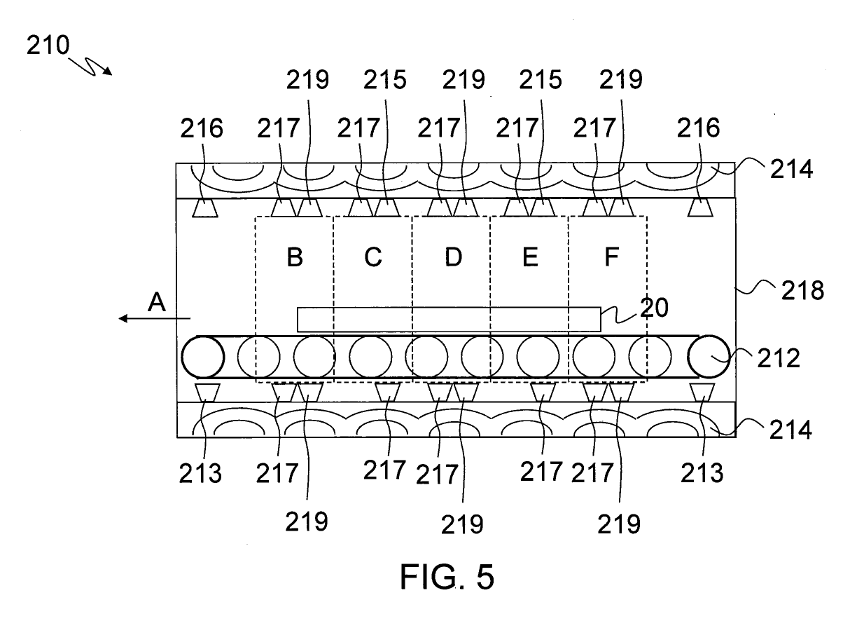

FIG. 5 shows a processing module 210 according to another embodiment. As shown in FIG. 5, the muffle 218 may include local exhaust ports 217, local separating gas introduction ports 219, and local process gas ports 215 that provide the capability for gas segregation within the muffle 218. While the muffle 218 does not include interior walls to physically separate the various processing gases, the processing gases may nonetheless be separated by the use of gas separation curtains, which are fast moving streams of gas. For example, processing gas may be introduced into the muffle 218 through local processing gas ports 215 into processing zones C and E and excess gas may be removed from zones C and E by exhaust ports 217 within the respective zones. The processing gasses may be the same or different within the different zones. Separating gas may be introduced into gas separation curtain zones B, D, F through local separating gas introduction ports 219 and removed by exhaust ports 217, creating a fast moving stream of gas that acts as a gas curtain separating the different processing zones C and E from each other. The gas separation curtains allow the muffle 118 to include multiple processing zones C, E, having incompatible gases without causing detrimental or dangerous reactions to occur between them. Hence, various process gases and vapors, for example, inert, toxic, oxidizing, reducing, and reactive gasses may simultaneously be used in the muffle 118. For example, in one embodiment, the muffle 218 may include multiple processing gas injectors 215 to allow for one or more of pre-treatment, deposition, activation, doping, and post-treatment sections within the same muffle 218. In addition to local introduction ports 219 and exhausts 217, the muffle 218 may also include outer introduction ports 216 and exhausts 213, which may be located on the outer edges of the muffle 218 to create outer gas curtains that block outside gas contamination from entering the muffle 218. Note that in the present embodiment, the separating gas used is an inert gas such as nitrogen gas.

The processing module 210 may be of a modular design to allow for a plurality of the modules 210 to be interlocked together in cascading fashion so that the output of one processing module 210 may become the input of the next processing module 210.

The temperature of the processing module 210 is controlled independently from that of the heating module 220 and the cooling module 230 to allow independent optimization of the processing conditions therein. In addition to the use of the gas separation curtain zones B, D, F described above to provide different processing zones C, E within the processing module 210, different portions of the heaters 214 may be heated to different temperatures to provide different amounts of heat to the substrate 20 within the different processing zones C, E. In addition to or in lieu of heaters 214, heated gas can also be injected into the module 210 to set a desired temperature within each processing zone in the muffle 218.

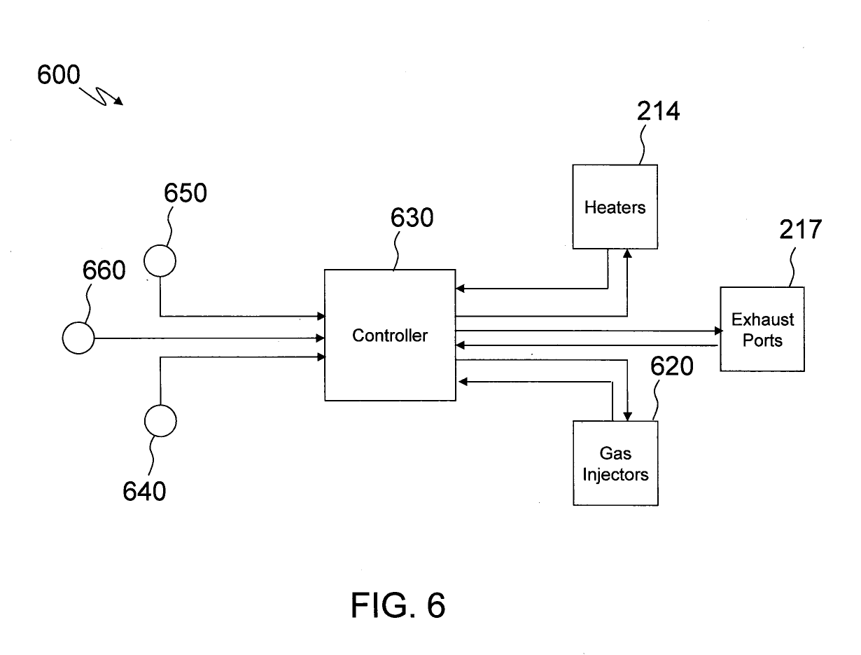

FIG. 6 shows a temperature feedback control loop 600 based on an in-situ temperature control to obtain the desired temperature within the processing module 210. The in-situ metrology serves to monitor and adjust for deviations in substrate temperature from the target temperature to achieve greater temperature consistency during the various thermal processes. The feedback control loop 600 includes a controller 630 to control the temperature of the heaters 214, the temperature of the gas output from the gas injectors 620, and the flow of the gas output from the gas injectors 620. Gas injectors 620 may include the local gas introduction ports 219, and local process gas ports 215. The controller 630 may be the same or different controller from controller 330. The controller 630 may receive input from the heaters 214 and the gas injectors 620 that indicates the temperature of the heaters 214 and the temperature and output volume of the gas from the gas injectors 620. The controller 630 may also receive input from a substrate temperature sensor 640 that monitors the temperature of the substrate 20. The substrate temperature sensor 640 may, for example, be a thermal imager in a spot configuration or line scanner configuration or a spectrometer. The controller 630 may also receive input from an ambient temperature sensor 650 that measures the internal temperature of the atmosphere inside the heating module 220. In one embodiment, the ambient temperature sensor 650 may monitor air temperature inside the various processing zones C, E. Various detectors 660, including but not limited to gas-phase fourier transform infrared spectroscopy (FTIR), optical emission spectroscopy (OES) and in-situ mass-spec etc., may be used to measure the quantity of chemical vapor in a processing zone C, E and send the information to the controller 630, which will maintain specific chamber ambient conditions by adjusting the quality of gas introduced through gas injectors 620 and/or the amount of gas removed through exhaust ports 217.

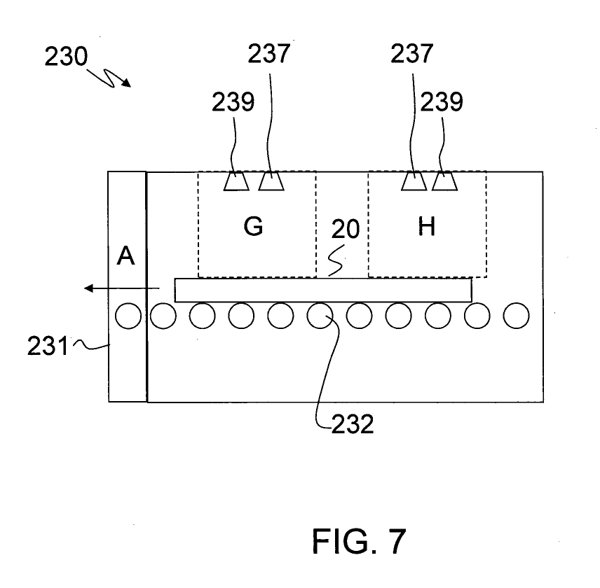

Referring again to FIG. 2, after the substrate 20 is processed in one or more processing modules 210, the substrate 20 may be transported along the belt 212 into the cooling module 230. FIG. 7 illustrates the cooling module 230 in greater detail. The cooling module 230 is configured for post-treatment cooling of the substrate 20. The temperature of the cooling module 230 is controlled independently of the processing module 210 and heating module 220 to allow for independent optimization of the cooling and/or quench rate to maintain an optimal stress/strain state within the substrate 20. In various embodiments, the cooling module 230 may be air and/or water cooled and may provide a rapid quench and/or slow cooling by injecting air and/or water through a plurality of inputs 239.

The cooling module 230 may include a plurality of rollers 232 to transport the substrate 20 through the module 230. The spacing between the plurality of rollers 232 allows heat to dissipate from the substrate 20, which provides a rapid and even cooling process. The rollers 232 have a further advantage over bulkier transport mechanisms in that they have a lower thermal mass. In other embodiments, the rollers 232 could be replaced with a different transport mechanism, so long as the transport mechanism allows heat to rapidly and evenly dissipate from the substrate 20. For example, the transport mechanism could be a wire mesh belt transport. The rollers 232 may be arranged within the cooling module 230 to position the substrate 20 so that there is symmetrical access from the top and bottom of the substrate 20 to allow cooling at an even rate, which may reduce thermal stress and breakage.

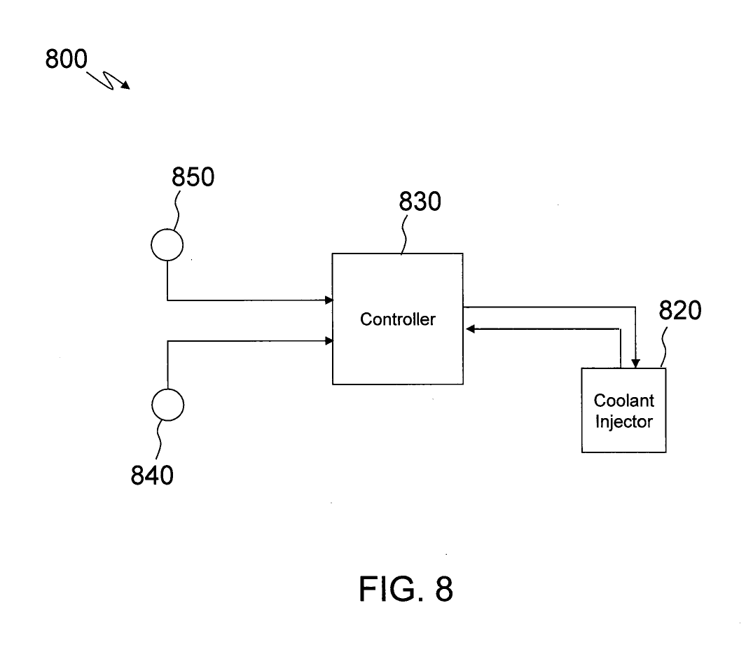

The temperature of the cooling module 230 is controlled independently of the processing module 210 and heating module 220 to allow independent optimization of the cooling conditions. FIG. 8 shows a temperature feedback control loop 800 based on an in-situ temperature control to obtain the desired temperature within the cooling module 230. The feedback control loop 800 includes a controller 830, which may be the same or different than controllers 330 and 630, to control the input of the coolant gas from the gas injector 820. It should be understood that the gas injector 820 could also be used to inject a liquid coolant, for example, water. The controller 830 may receive input from the coolant gas injector 820 that indicates the temperature and output volume of the gas from the gas injector 820. The controller 830 may also receive input from a substrate temperature sensor 840 that monitors the temperature of the substrate 20. The substrate temperature sensor 840 may, for example, be a thermal imager in a spot configuration or line scanner configuration or a spectrometer. The controller 830 may also receive input from an ambient temperature sensor 850 that measures the internal temperature of the atmosphere inside the cooling module 230. In one embodiment, the ambient temperature sensor 850 may monitor air temperature inside the cooling module 230 at various locations. Using the various sensor inputs and controlling the output of the coolant gas injector 820, the temperature feedback control loop may provide for optimized cooling of the substrate 20.

FIG. 7 also shows how cooling module 230 may be arranged into different zones. As shown in FIG. 7, the cooling module 230 may include two discrete cooling zones G, H. The first zone H may be an initial cooling zone that cools the substrate 20 down below a critical temperature in an inert atmosphere, for example, using argon or nitrogen injected through a coolant input 239 and exhausted through exhaust port 237. The second zone G may be a subsequent cooling zone that cools the substrate 20 down to a post processing temperature, for example, using clean dry air injected through a coolant input 239 and exhausted through exhaust port 237. In other embodiments, the same gas could be used in both the first H and second G zones. The first H and second G zones may use the same or different cooling rates. The cooling module 230 may also have a dual containment body 231, i.e., a second body 231 arranged around the cooling module 230, to prevent the escape of process byproducts and/or reactants from the processing module 210.

In the embodiment shown in FIG. 2, a heating module 220, a processing module 210, and a cooling module 230 are coupled sequentially to each other. In other embodiments, the modules 210, 220, 230 may be arranged in different orders and/or may include additional modules depending on the particular process needs.

While disclosed embodiments have been described in detail, it should be readily understood that the invention is not limited to the disclosed embodiments. Rather, the disclosed embodiments can be modified to incorporate any number of variations, alterations, substitutions or equivalent arrangements not heretofore described.

What is claimed as new and desired to be protected by Letters Patent of the United States is:

1. An apparatus for processing a substrate, said apparatus comprising:
a heating modular unit configured to heat the substrate to a first predetermined temperature prior to substrate processing;
a processing modular unit coupled to the heating modular unit for heating and maintaining the temperature of the substrate at a second predetermined temperature during substrate processing; and
a cooling modular unit coupled to the heating and processing modular units and configured to cool the substrate to a third predetermined temperature after substrate processing.

2. The apparatus of claim 1,
wherein the heating modular unit further comprises:
a first transport mechanism for transporting the substrate through the heating modular unit; and
a first device for establishing the first predetermined temperature within the heating modular unit;
wherein the processing modular unit further comprises:
a second transport mechanism for transporting the substrate through the processing modular unit;
a system for exposing the substrate to vaporized material; and
a second device for establishing the second predetermined temperature within the processing modular unit; and
wherein the cooling modular unit further comprises:
a third transport mechanism for transporting the substrate through the cooling modular unit; and
a third device for establishing the third predetermined temperature within the cooling modular unit.

3. The apparatus of claim 2, wherein the heating modular unit further comprises a first control system for monitoring the temperature within the heating modular unit and for controlling the first device to maintain the first predetermined temperature within the heating modular unit.

4. The apparatus of claim 3, wherein the processing modular unit further comprises a second control system for monitoring the temperature within the processing modular unit and for controlling the second device to maintain the second predetermined temperature within the processing modular unit.

5. The apparatus of claim 4, wherein the cooling modular unit further comprises a third control system for monitoring the temperature within the cooling modular unit and for controlling the third device to maintain the third predetermined temperature within the cooling modular unit.

6. The apparatus of claim 5, wherein the first control system and the second control system are part of a single control system.

7. The apparatus of claim 2, wherein the processing modular unit comprises a plurality of exhaust ports and gas introduction ports for generating a plurality of gas separation curtains for separating the processing modular unit into a plurality of zones.

8. The apparatus of claim 7, wherein the plurality of zones comprise:
at least a first processing zone using a first vaporized material; and
at least a second processing zone using a second vaporized material,
wherein first and second processing zones are separated by the gas separation curtains.

9. The apparatus of claim 5, wherein the processing modular unit is configured to perform a process on the substrate requiring a heating of the substrate.

10. The apparatus of claim 9, wherein the process comprises at least one of surface etching, dopant introduction, dopant activation, film deposition, and surface passivation on the substrate.

11. The apparatus of claim 5, wherein the second transport mechanism is a transport belt.

12. The apparatus of claim 9, wherein the processing modular unit comprises:
a muffle in which processing of the substrate occurs;
a plurality of heaters arranged outside of and above the muffle; and
a plurality of heaters arranged outside of and below the muffle.

13. The apparatus of claim 12, wherein the second transport mechanism is arranged within the muffle such that the substrate arranged on the second transport mechanism is equidistant from the plurality of heaters above the muffle and the plurality of heaters below the muffle.

14. The apparatus of claim 12, wherein the second control system executes a temperature feedback control loop to control the temperature of the plurality of heaters based on the in-situ temperature of the processing modular unit and the substrate temperature.

15. The apparatus of claim 14, wherein the processing modular unit further comprises a thermal imager to measure the temperature of the substrate.

16. The apparatus of claim 5, wherein the first device comprises a first heater arranged at a top of the interior of the heating modular unit and a second heater arranged at a bottom of the interior of the heating modular unit.

17. The apparatus of claim 16, wherein the first transport mechanism is arranged within the heating modular unit such that the substrate arranged on the first transport mechanism will be approximately equidistant from the top and the bottom of the heating modular unit.

18. The apparatus of claim 16, wherein the first device further comprises a gas injector for injecting heated gas into the heating modular unit.

19. The apparatus of claim 18, wherein the first control system executes a temperature feedback control loop to control the first heater and the gas injector based on the in-situ temperature of the heating modular unit and the temperature of the substrate.

20. The apparatus of claim 5, wherein the first device comprises a gas injector for injecting heated gas into the heating modular unit.

21. The apparatus of claim 5, wherein the heating modular unit further comprises a thermal imager to measure the temperature of the substrate.

22. The apparatus of claim 2, wherein the first transport mechanism comprises a plurality of rollers.

23. The apparatus of claim 5, wherein the third transport mechanism is arranged within the cooling modular unit such that the substrate arranged on the third transport mechanism will be approximately equidistant from the top and the bottom of the cooling modular unit.

24. The apparatus of claim 5, wherein the cooling modular unit comprises a first cooling zone for cooling the substrate to a temperature below a reaction temperature and a second cooling zone for further cooling the substrate.

25. The apparatus of claim 5, wherein the third device comprises a coolant injector for injecting coolant into the cooling modular unit.

26. The apparatus of claim 25, wherein the third control system executes a temperature feedback control loop to control the coolant injector based on the in-situ temperature of the cooling modular unit and the temperature of the substrate.

27. The apparatus of claim 5, wherein the cooling modular unit further comprises a thermal imager to measure the temperature of the substrate.

28. The apparatus of claim 5, wherein the cooling modular unit further comprises a dual containment body.

29. The apparatus of claim 5, wherein the third transport mechanism comprises a plurality of rollers.

30. A method of heat-treating a substrate in a modular apparatus, said method comprising:
transporting the substrate through a first module using a first transport mechanism;
heating the substrate to a first temperature in the first module;
monitoring the temperature within the first module and controlling the temperature within the first module to maintain a first predetermined temperature therein;
transporting the substrate through a second module using a second transport mechanism, said second module being coupled to said first module;
heating the substrate in the second module to a second temperature;
processing said substrate in said second module; and
monitoring the temperature within the second module and controlling the temperature of the second module to maintain a second predetermined temperature therein.

31. The method of claim 30, wherein the first predetermined temperature and the second predetermined temperature are different temperatures.

32. The method of claim 30, wherein the first module is heated using a first plurality of heaters and wherein the second module is heated using a second plurality of heaters.

33. The method of claim 32, wherein at least one heater of the first plurality of heaters is arranged approximately 2 to 6 inches from the substrate arranged on the first transport mechanism.

34. The method of claim 32, further comprising controlling the temperature of the first module using a temperature feedback control loop to adjust the temperature of the heaters based on the in-situ temperature of the first module and the temperature of the substrate.

35. The method of claim 34, further comprising maintaining the temperature of the substrate at +/−1° C. of a target temperature prior to transporting the substrate into the second module.

36. The method of claim 30, further comprising measuring position, dimensions, and temperature of the substrate within the first module.

37. The method of claim 30, further comprising introducing heating gas into the first module.

38. The method of claim 30, further comprising performing at least one of vapor deposition, surface etching, dopant introduction, dopant activation, film deposition, and surface passivation on the substrate in the second module.

39. The method of claim 30, further comprising separating two different vaporized materials from each other within the second module using a gas separation curtain.

40. The method of claim 32, further comprising controlling the temperature within the second module by adjusting the temperature of the second plurality of heaters therein.

41. A method of heat treating a substrate in a modular apparatus, said method comprising:
transporting the substrate through a processing module using a first transport mechanism;
heating the substrate to a first temperature in the processing module using a plurality of heaters;
introducing a vaporized material into the processing module through a vapor introduction port;
monitoring the temperature within the processing module and controlling the temperature of the plurality of heaters to maintain a first predetermined temperature within the processing module;
transporting the substrate through a cooling module using a second transport mechanism after transporting the substrate through the processing module;
cooling the substrate to a second temperature in the cooling module using a coolant;
monitoring the temperature within the cooling module and controlling the temperature and/or the amount of the coolant used to maintain a second predetermined temperature within the cooling module.

42. The method of claim 41, further comprising controlling the temperature of the cooling module by adjusting the temperature and/or the amount of coolant used.

43. The method of claim 41, further comprising measuring position, dimensions, and temperature of the substrate in the cooling module.

44. The method of claim 41, further comprising cooling the substrate to the first temperature in a first zone of the cooling module and cooling the substrate to the second temperature in a second cooling zone in the cooling module.
